(19) United States
(12) Patent Application Publication
(10) Pub. No.: US 2007/0104848 A1
(43) Pub. Date: May 10, 2007

(54) Carbonated drink compositions and methods of making the same

(76) Inventors: Donald Thrasher, Los Angeles, CA (US); Bill Bluemer, West Chicago, IL (US)

Correspondence Address: WITHERS & KEYS, LLC, P. O. BOX 2049, MCDONOUGH, GA, 30253, US

(21) Appl. No.: 11/271,548

(22) Filed: Nov. 10, 2005

(51) Int. Cl. A23L 2/00

(52) U.S. Cl. 426/590

(57) ABSTRACT

Carbonated drink compositions are disclosed. Methods of making carbonated drink compositions are also disclosed.

### FIELD OF THE INVENTION

The present invention relates generally to carbonated drink compositions. The present invention further relates to methods of making and carbonated drink compositions.

### BACKGROUND OF THE INVENTION

There is a need in the art of carbonated drink compositions for carbonated drink compositions having exceptional taste, low calorie content, and low carbohydrate content, wherein the carbonated drink compositions are free of artificial sweeteners.

### SUMMARY OF THE INVENTION

The present invention is directed to carbonated drink compositions. The drink compositions comprise a combination of ingredients resulting in a carbonated drink having exceptional taste, low calorie content, and low carbohydrate content, wherein the carbonated drink compositions are free of artificial sweeteners. Instead of using artificial sweeteners, the carbonated drink compositions of the present invention contain a combination of natural sweeteners comprising (i) stevia and (ii) erythritol.

Accordingly, the present invention is directed to carbonated drink compositions. In one exemplary embodiment of the present invention, the carbonated drink compositions comprise water; carbon dioxide or carbonic acid in the water; and a combination of natural sweeteners comprising stevia, and erythritol. The water is desirably water that has been filtered through a reverse osmosis process to remove salts and other materials (e.g., dissolved solids) typically found in water. The carbonated drink compositions of the present invention may further comprise a number of additional components in order to provide a particular flavor, a particular color, and/or particular properties (e.g., product stability) to the carbonated drink compositions.

In a further exemplary embodiment of the present invention, the carbonated drink composition comprises carbonated water; a combination of natural sweeteners comprising stevia and erythritol; one or more flavors selected from the group consisting of cola flavor and orange flavor; and one or more additives selected from the group consisting of phosphoric acid, citric acid, sodium benzoate, and any combination thereof; wherein the carbonated drink composition is substantially free of artificial sweeteners, contains no calories, and has less than about 1.0 carbohydrate per twelve ounce serving.

In yet a further exemplary embodiment of the present invention, the carbonated drink composition comprises carbonated water in an amount ranging from about 99.980 to about 99.995 wt %, wherein the carbonated water contains at least 0.005 wt % carbon dioxide or carbonic acid; stevia in an amount ranging from about 0.0001 to about 0.0010 wt %; erythritol in an amount ranging from about 0.0010 to about 0.0050 wt %; at least one flavor in an amount ranging from about 0.0010 to about 0.0050 wt %; and one or more additives selected from the group consisting of phosphoric acid, citric acid, sodium benzoate, and any combination thereof; wherein all weight percents are based on a total weight of the carbonated drink composition; and wherein the carbonated drink composition is substantially free of artificial sweeteners, contains no calories, and has less than about 1.0 carbohydrates per twelve ounce serving.

The present invention is also directed to methods of making carbonated drink compositions. In one exemplary embodiment of the present invention, the method of making a carbonated drink composition comprises the steps of (i) forming a natural sweetener combination comprising stevia and erythritol; and (ii) incorporating the natural sweetener combination and carbon dioxide into an aqueous composition. In a further exemplary embodiment of the present invention, the method of making a carbonated drink composition comprises the steps of (i) forming a syrup containing water, a natural sweetener package comprising a combination of stevia and erythritol, one or more optional drink flavors, one or more optional pH control agents, and one or more optional additives; (ii) adding a balance of water to the syrup to form a non-carbonated mixture; and (iii) adding carbon dioxide to the non-carbonated mixture to form a carbonated mixture.

These and other features and advantages of the present invention will become apparent after a review of the following detailed description of the disclosed embodiments and the appended claims.

### DETAILED DESCRIPTION OF THE INVENTION

The present invention is directed to carbonated drink compositions. The present invention is further directed to methods of making carbonated drink compositions.

The carbonated drink compositions of the present invention may comprise a number of components. A description of individual components and combinations of individual components is provided below.

I. Carbonated Drink Composition Components

The carbonated drink compositions of the present invention may comprise one or more of the following components.

A. Water

The carbonated drink compositions of the present invention comprise water. Soft or hard water may be used in the present invention, although soft water is more desirable. As used herein, the term “soft water” refers to water containing less than about 60 ppm of water hardness expressed as calcium carbonate content. As used herein, the term “hard water” refers to water containing more than about 60 ppm of water hardness expressed as calcium carbonate content, while “very hard water” refers to water containing more than about 180 ppm of water hardness expressed as calcium carbonate content. The carbonated drink compositions of the present invention may be formed using water available from any municipal water-treatment facility.

In one exemplary embodiment, the carbonated drink compositions of the present invention are prepared by filtering the water using a reverse osmosis process. The reverse osmosis process removes about to or greater than 90% of the total dissolved solids from the water (e.g., municipal water). The resulting filtered water has less than 10 ppm of water hardness expressed as calcium carbonate content. In a further alternative embodiment, the water is processed through a water filtration process, flocculation, to reduce the alkalinity of the water (e.g., calcium carbonate, etc.) to less than about 50 ppm.

The carbonated drink compositions of the present invention typically comprise greater than about 95 weight percent (wt %) of water (desirably filtered water) based on a total weight of the carbonated drink composition. In exemplary embodiments, the carbonated drink compositions of the present invention comprise greater than about 96 wt % (or greater than about 97 wt % or greater than about 98 wt % or greater than about 99 wt %) of water (desirably filtered water) based on a total weight of the carbonated drink composition. Desirably, the carbonated drink compositions of the present invention comprise from about 98.00 to about 99.99 wt % water (more desirably filtered water) based on a total weight of the carbonated drink composition. In one desired embodiment of the present invention, the carbonated drink compositions comprise about 99.98 to about 99.99 wt % water (more desirably filtered water) based on a total weight of the carbonated drink composition.

B. Natural Sweeteners

The carbonated drink compositions of the present invention comprise a combination of natural sweeteners, wherein the combination comprises stevia and erythritol. The sweetener combination may further comprise additional natural sweeteners, but are free of any artificial sweeteners such as aspartame and saccharine. In one desired embodiment of the present invention, the carbonated drink compositions comprise a combination of natural sweeteners consisting solely of stevia and erythritol.

Each of the natural sweeteners may be present in the carbonated drink compositions in an amount of up to about 1.0 weight percent (wt %) based on a total weight of the carbonated drink composition. Typically, stevia and erythritol are present in the carbonated drink compositions at a weight ratio of stevia to erythritol ranging from about 1:2 to about 1:8, more typically, from about 1:4 to about 1:6.

Stevia is typically present in the carbonated drink compositions in an amount ranging from about 0.0001 to about 0.0010 wt %, more desirably from about 0.0004 to about 0.0008 wt %, even more desirably from about 0.0006 to about 0.0007 wt % based on a total weight of the carbonated drink composition. Erythritol is typically present in the carbonated drink compositions in an amount ranging from about 0.0010 to about 0.0050 wt %, more desirably from about 0.0015 to about 0.0040 wt %, even more desirably from about 0.0025 to about 0.0032 wt % based on a total weight of the carbonated drink composition.

A number of commercially available natural sweeteners may be used in the present invention. Suitable commercially available natural sweeteners include, but are not limited to, stevia commercially available from Stevia Canada (Ontario, Canada) and sold under the trade designation STEVIA MAX 80; and erythritol commercially available from Cargill, Inc. (Minneapolis, Minn.) and sold under the trade designation ERIDEX™.

C. Carbon Dioxide/Carbonic Acid

The carbonated drink compositions of the present invention comprise carbon dioxide and/or carbonic acid formed from the reaction between carbon dioxide and water. Carbon dioxide may be added to the carbonated drink compositions of the present invention using any known technique. Typically, carbon dioxide is added to the carbonated drink compositions of the present invention under pressure (i.e., greater than atmospheric pressure) in order to obtain a desired amount of carbonation within the carbonated drink compositions.

As used herein, the amount of carbon dioxide and/or carbonic acid in the carbonated drink compositions of the present invention is a measure of the increase in weight of the drink composition as a result of a carbonation process step. Consequently, whether the carbon dioxide is present as carbon dioxide or as carbonic acid, the “amount of carbon dioxide and/or carbonic acid” as used in the present invention represents an amount of carbon dioxide or carbonic acid within the carbonated drink composition resulting from a carbonation process step.

Typically, the amount of carbon dioxide and/or carbonic acid in the carbonated drink compositions of the present invention is at least about 0.005 wt % carbon dioxide or carbonic acid based on a total weight of the carbonated drink composition. Desirably, carbon dioxide and/or carbonic acid is present in the carbonated drink compositions of the present invention in an amount ranging from about 0.005 to about 0.010 wt %, more desirably from about 0.005 to about 0.008 wt %, even more desirably from about 0.0054 to about 0.0068 wt % based on a total weight of the carbonated drink composition.

Carbon dioxide for use in the present invention is commercially available from a number of sources. Suitable commercially available carbon dioxide includes, but is not limited to, carbon dioxide commercially available from Air Liquide (Houston, Tex.).

D. Flavors

The carbonated drink compositions of the present invention may further comprise one or more flavors. Suitable flavors include, but are not limited to, cola flavor, orange flavor, cherry flavor, lime flavor, root beer flavor, etc. In one exemplary embodiment of the present invention, the carbonated drink compositions of the present invention comprise either a cola flavor or an orange flavor.

When present, each of the one or more flavors may be present in the carbonated drink compositions in an amount of up to about 1.0 weight percent (wt %) based on a total weight of the carbonated drink composition. Typically, each of the one or more flavors are independently present in the carbonated drink compositions in an amount ranging from about 0.0010 to about 0.0050 wt %, more desirably from about 0.0020 to about 0.0035 wt %, even more desirably from about 0.0025 to about 0.0028 wt % based on a total weight of the carbonated drink composition.

A number of commercially available flavors may be used in the present invention. Suitable commercially available flavors include, but are not limited to, cola flavor commercially available from Degussa Flavors & Fruit Systems Inc. (Waukesha, Wis.) and sold under the trade designation Cola CO 18, and orange flavor commercially available from The American Bottling, Co. (Northlake, Ill.) and sold under the trade designation 4002 Orange Flavor.

E. pH Control Agents

The carbonated drink compositions of the present invention may comprise one or more pH control agents in order to provide one or more properties to the carbonated drink compositions including, but not limited to, a desired pH, an adjustment in composition taste, a desired degree of anti-microbial protection, etc. Suitable pH control agents for use in the present invention include, but are not limited to, citric acid, phosphoric acid, sodium citrate, sodium benzoate, benzoic acid, sodium citrate, or a combination thereof. Desirably, the pH control agent is citric acid (i.e., 2-hydroxy-1,2,3-propanetricarboxylic acid), phosphoric acid, sodium benzoate, or any combination thereof.

When present, each of the one or more pH control agents may be present in the carbonated drink compositions in an amount of up to about 1.0 weight percent (wt %) based on a total weight of the carbonated drink composition. Typically, each of the one or more pH control agents are independently present in the carbonated drink compositions in an amount ranging from about 0.0001 to about 0.0030 wt %, more desirably from about 0.0003 to about 0.0020 wt %, even more desirably from about 0.0005 to about 0.0015 wt % based on a total weight of the carbonated drink composition.

A number of commercially available pH control agents may be used in the present invention. Suitable commercially available pH control agents include, but are not limited to, phosphoric acid commercially available from Brenntag Great Lakes (Chicago, Ill.) and sold as phosphoric acid (75%); citric acid commercially available from Jiali International (Shanghai, China); and sodium benzoate commercially available from Velsicol Chemical Corporation (Rosemont, Ill).

In one exemplary embodiment of the present invention, the carbonated drink compositions desirably comprise at least one flavor in the form of a cola flavor, and further comprise one or more pH control agents in the form of phosphoric acid. In this embodiment, the carbonated drink composition desirably comprises phosphoric acid in an amount ranging from about 0.0001 to about 0.0010 wt % based on a total weight of the carbonated drink composition.

In a further exemplary embodiment of the present invention, the carbonated drink compositions desirably comprise at least one flavor in the form of an orange flavor, and further comprise one or more pH control agents in the form of citric acid and sodium benzoate. In this embodiment, the carbonated drink composition desirably comprises citric acid in an amount ranging from about 0.0010 to about 0.0030 wt %, and sodium benzoate in an amount ranging from about 0.0001 to about 0.0010 wt %, wherein the weight percents are based on a total weight of the carbonated drink composition.

F. Other Additives

The carbonated drink compositions of the present invention may further comprise one or more additives in order to provide one or more properties to the carbonated drink compositions including, but not limited to, a desired color, an adjustment in composition viscosity or thickening (e.g., a thickening agent), etc. Suitable additives for use in the present invention include, but are not limited to, food colorants, thickening agents, etc.

When present, each of the one or more additives may be present in the carbonated drink compositions in an amount of up to about 1.0 weight percent (wt %) based on a total weight of the carbonated drink composition. Typically, each of the one or more additives are independently present in the carbonated drink compositions in an amount ranging from about 0.0001 to about 0.0010 wt %, more desirably from about 0.0001 to about 0.0005 wt %, even more desirably from about 0.0001 to about 0.0002 wt % based on a total weight of the carbonated drink composition.

A number of commercially available additives may be used in the present invention. Suitable commercially available additives include, but are not limited to, caramel color commercially available from Sethness Products (Chicago, Ill.) and sold as DS 400 Caramel Color; gum acaica commercially available from Alfred Wolff Co. (Park Ridge, Ill.) and sold as 8074S Gum Acacia; glycerol of wood rosin (from pine trees) commercially available from Flavor Concepts (West Chicago, Ill.) and sold as #216989 Cloud Emulsion; Red #40 commercially available from Noveon (Cincinnati, Ohio); and Yellow #6 commercially available from Noveon (Cincinnati, Ohio).

II. Methods of Making Carbonated Drink Compositions

The present invention is further directed to methods of making the above-described carbonated drink compositions. In one exemplary embodiment of the present invention, the method of making a carbonated drink composition comprises the steps of (i) forming a natural sweetener combination comprising stevia and erythritol; and (ii) incorporating the natural sweetener combination and carbon dioxide into an aqueous composition. The method may further comprise the step of (iii) incorporating one or more flavors, one or more pH control agents, and/or one or more additives into the aqueous composition.

In a further exemplary embodiment of the present invention, the method of making a carbonated drink composition comprises the steps of (i) forming a syrup containing water, a natural sweetener package comprising a combination of stevia and erythritol, one or more optional drink flavors, one or more optional pH control agents, and one or more optional additives; (ii) adding a balance of water to the syrup to form a non-carbonated mixture; and (iii) adding carbon dioxide to the non-carbonated mixture to form a carbonated mixture.

In any of the methods of making a carbonated drink composition of the present invention, the order in which components are added to a given mixture is not critical. However, it is desirable for the following order to take place when added components to water: (1) the natural sweetener package described above, (2) one or more optional drink flavors, (3) one or more optional additives (e.g., colorants, etc.), (4) one or more optional pH control agents (e.g., citric acid), and (5) carbon dioxide.

As discussed above, the step of incorporating carbon dioxide into the aqueous composition may be performed using any conventional carbonation step and carbonation device. Typically, the step of incorporating carbon dioxide into the aqueous composition comprises utilizing a carbonation device to carbonate a given composition according to the carbonation device manufacturers' specification (e.g., mixing the components at a suitable temperature and pressure for commercial carbonation). Suitable carbonation devices and methods of carbonation for use in the present invention include, but are not limited to, carbonation devices and methods similar to those described in U.S. Pat. Nos. 4,882,097; 4,358,296; 4,313,370; 4,300,923; 4,191,784; and 4,112,828, the subject matter of which is hereby incorporated by reference in their entirety.

Suitable commercially available carbonation devices for use in the present invention include, but are not limited to, Mojonnier Bros. Co. carbonation devices, such as Model No. 4460 with E Flo-Mix, commercially available from Mojonnier Bros. Co. (Chicago, Ill.) or used equipment wholesalers such as, for example, Litchfield Packaging Machinery Corporation (Morris, Conn.).

In the above-described methods of making a carbonated drink composition, the methods may further comprise one or more of the following steps: (i) filtering water through a reverse osmosis device to remove any unwanted materials from the water; (ii) mixing the components of the carbonated drink composition at room temperature (e.g., about 22° C. (72° F.)) or more typically at a lower temperature (e.g., from about 2° C. (35° F.) to about 5° C. (40° F.)); and (iii) packaging the carbonated drink composition in a container suitable for carbonated drink compositions (e.g., aluminum cans, glass bottles, etc.), (ii).

In the filtering step, any known reverse osmosis device may be used in the present invention. Suitable reverse osmosis devices include, but are not limited to, reverse osmosis devices commercially available from GE Osmonics (Milwaukee. Wis.), such as Model No. RO-BEV-18-SS.

The methods of making carbonated drink compositions of the present invention may be used to prepare a variety of carbonated drink compositions. In one exemplary embodiment, the method of the present invention results in a carbonated drink composition comprising filtered water (e.g., filtered during a reverse osmosis process step) in an amount ranging from about 99.98 to about 99.99 wt %; carbon dioxide or carbonic acid in an amount ranging from about 0.005 to about 0.008 wt %; stevia in an amount ranging from about 0.0001 to about 0.0010 wt %; erythritol in an amount ranging from about 0.0010 to about 0.0050 wt %; and at least one flavor in an amount ranging from about 0.0010 to about 0.0050 wt %; wherein all weight percents are based on a total weight of the carbonated drink composition. Desirably, the resulting carbonated drink composition is substantially free of artificial sweeteners, contains no calories, and has less than about 1.0 carbohydrate per twelve ounce serving (e.g., a net carbohydrate content per twelve ounce serving of zero given that erythritol is a natural carbohydrate).

The methods of the present invention may be used to make carbonated drink compositions of the present invention may be used to prepare a variety of carbonated drink compositions for the healthy-minded consumer. The carbonated drink compositions of the present invention have exceptional taste, low calorie content, and low carbohydrate content, without the use of artificial sweeteners (e.g., aspartame and saccharine), other sugars (e.g., glucose, fructose, oligosaccharide), sweetness enhancing agents (e.g., yeast extracts), or any other alleged health-providing constituents (e.g., milk products or components, vitamins such as vitamin E, Ginkgo biloba plant extract, and kudzu plant extract).

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of a Cola Soft Drink

An exemplary cola flavored carbonated drink composition of the present invention having a composition as shown in Table 1 below was prepared as follows.

TABLE 1
Cola Flavored Carbonated Drink Composition Components

| Carbonated Drink | | | |
|---|---|---|---|
| Composition | | | |
| Components | Source | Amount | Wt % |
| water | water from municipal | 480.5 gallons | 99.9872% |
| | source that has been | | |
| | filtered using a GE | | |
| | Osmonics (Milwaukee. | | |
| | WI) reverse osmosis | | |
| | device Model No. RO- | | |
| | BEV-18-SS | | |
| carbon dioxide | Air Liquide | about 0.3 lbs. | 0.0068% |
| | Houston, TX) | | |
| STEVIA MAX 80 | Stevia Canada | 2.4 lbs. | 0.0006% |
| (powder) | (Ontario, Canada) | | |
| ERIDEX ™ | Cargill, Inc. | 10.0 lbs.** | 0.0025% |
| erythritol | (Minneapolis, MN) | | |
| Cola CO18 | Degussa Flavors & | 1 gallon | 0.0025% |
| | Fruit Systems Inc. | | |
| | (Waukesha, | | |
| | Wisconsin) | | |
| phosphoric acid | Brenntag Great Lakes | 0.12 gallons | 0.0004% |
| (75%) | (Chicago, IL) | | |
| food chemical | | | |
| (FCC V) | | | |

**The STEVIA MAX 80 (powder) and ERIDEX ™ erythritol were premixed in about 0.78 gallons of filtered water.

About 78.5 gallons of filtered water was used to form a syrup by adding 12.4 lbs. of a stevia/erythritol premix, 1 gallon of cola flavor, and 0.12 gallons of phosphoric acid (0.75%) solution to the filtered water. The intermediate composition was mixed at atmospheric pressure and room temperature for about 5 minutes. The resulting mixture was diluted with 402 gallons of filtered water to form a diluted composition, which was mixed at atmospheric pressure and room temperature for about 5 minutes.

The diluted composition was then carbonated using a commercial carbonation device (Model #4460 with E Flo-Mix, commercially available from Mojonnier Bros. Co. (Chicago, Ill.)) to introduce carbon dioxide into the diluted composition in accordance with the manufacturer's specifications at a temperature of about 2° C. (35° F.) to about 7° C. (45° F.). The resulting carbonated drink composition was subsequently packaged in aluminum cans, forming about 214.4 cases of cola soft drink (24 cans containing 12 oz. each).

### EXAMPLE 2

### Preparation of an Orange Flavored Soft Drink

An exemplary orange flavored carbonated drink composition of the present invention having a composition as shown in Table 2 below was prepared as follows.

TABLE 2
Orange Flavored Carbonated Drink Composition Components

| Carbonated Drink | | | |
|---|---|---|---|
| Composition | | | |
| Components | Source | Amount | Wt % |
| water | water from municipal | 363.8 gallons | 99.9859% |
| | source that has been | | |
| | filtered using a GE | | |
| | Osmonics (Milwaukee. | | |
| | WI) reverse osmosis | | |
| | device Model No. RO- | | |
| | BEV-18-SS | | |
| carbon dioxide | Air Liquide | about 0.2 lbs. | 0.0054% |
| | Houston, TX) | | |
| STEVIA MAX 80 | Stevia Canada | 2.13 lbs. | 0.0007% |
| (powder) | (Ontario, Canada) | | |
| ERIDEX ™ | Cargill, Inc. | 9.72 lbs. | 0.0032% |
| erythritol | (Minneapolis, MN) | | |
| 4002 Orange | The American | 1 gallon | 0.0028% |
| Flavor | Bottling, Co. | | |
| | (Northlake, IL) | | |
| citric acid | Cargill, Inc. | 4.63 lbs. | 0.0015% |
| | (Eddyville, IA) | | |
| sodium benzoate | Velsicol Chemical | 1.52 lbs.** | 0.0005% |
| | Corporation | | |
| | (Rosemont, IL) | | |

**The STEVIA MAX 80 (powder), ERIDEX ™ erythritol and sodium benzoate were premixed in about 1.2 gallons of filtered water.

About 58.8 gallons of filtered water was used to form a syrup by adding 13.37 lbs. of a stevia/erythritol/sodium benzoate premix, 1 gallon of orange flavor, and 4.63 lbs. of citric acid to the filtered water. The intermediate composition was mixed at atmospheric pressure and room temperature for about 5 minutes. The resulting mixture was diluted with 305 gallons of filtered water to form a diluted composition, which was mixed at atmospheric pressure and room temperature for about 5 minutes.

The diluted composition was then carbonated using the apparatus and process as described in Example 1 to introduce carbon dioxide into the diluted composition. The resulting carbonated drink composition was subsequently packaged in aluminum cans, forming about 162.6 cases of orange soft drink (24 cans containing 12 oz. each).

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A carbonated drink composition comprising:
water;
carbon dioxide or carbonic acid in said water; and
a combination of natural sweeteners comprising:
stevia, and
erythritol.

2. The carbonated drink composition of claim 1, wherein said water comprises water that has been filtered through a reverse osmosis process.

3. The carbonated drink composition of claim 1, wherein said combination of natural sweeteners comprises a weight ratio of stevia to erythritol ranging from about 1:4 to about 1:6.

4. The carbonated drink composition of claim 1, wherein said carbonated drink composition is free of artificial sweeteners.

5. The carbonated drink composition of claim 1, wherein said carbonated drink composition contains no calories, and has less than about 1.0 carbohydrate per twelve ounce serving.

6. The carbonated drink composition of claim 1, further comprising one or more flavors.

7. The carbonated drink composition of claim 6, wherein said one or more flavors comprises a cola flavor or an orange flavor.

8. The carbonated drink composition of claim 1, wherein said carbonated drink composition comprises:
filtered water in an amount ranging from about 99.98 to about 99.99 wt %;
carbon dioxide or carbonic acid in an amount ranging from about 0.005 to about 0.008 wt %;
stevia in an amount ranging from about 0.0001 to about 0.0010 wt %;
erythritol in an amount ranging from about 0.0010 to about 0.0050 wt %; and
at least one flavor in an amount ranging from about 0.0010 to about 0.0050 wt %;
wherein all weight percents are based on a total weight of said carbonated drink composition.

9. The carbonated drink composition of claim 8, wherein said at least one flavor comprise a cola flavor, and said carbonated drink composition further comprises:
phosphoric acid in an amount ranging from about 0.0001 to about 0.0010 wt % based on a total weight of said carbonated drink composition.

10. The carbonated drink composition of claim 8, wherein said at least one flavor comprise an orange flavor, and said carbonated drink composition further comprises:
citric acid in an amount ranging from about 0.0010 to about 0.0030 wt %; and
sodium benzoate in an amount ranging from about 0.0001 to about 0.0010 wt %;
wherein all weight percents are based on a total weight of said carbonated drink composition.

11. A method of making the carbonated drink composition of claim 1, said method comprising the steps of:
forming a mixture of water and a combination of natural sweeteners comprising stevia and erythritol; and
introducing carbon dioxide into the mixture so as to form said carbonated drink composition.

12. A carbonated drink composition comprising:
carbonated water;
a combination of natural sweeteners comprising:
stevia, and
erythritol;
one or more flavors selected from the group consisting of cola flavor and orange flavor; and
one or more additives selected from the group consisting of phosphoric acid, citric acid, sodium benzoate, and any combination thereof;
wherein said carbonated drink composition is substantially free of artificial sweeteners, contains no calories, and has less than about 1.0 carbohydrate per twelve ounce serving.

13. The carbonated drink composition of claim 12, wherein said carbonated water comprises water that has been filtered through a reverse osmosis process and then carbonated so as to produce carbonated water containing at least 0.005 wt % carbon dioxide or carbonic acid based on a total weight of said carbonated drink composition.

14. The carbonated drink composition of claim 12, wherein said carbonated drink composition comprises:
carbonated water in an amount ranging from about 99.980 to about 99.995 wt %;
stevia in an amount ranging from about 0.0001 to about 0.0010 wt %;
erythritol in an amount ranging from about 0.0010 to about 0.0050 wt %; and
at least one flavor in an amount ranging from about 0.0010 to about 0.0050 wt %;
wherein all weight percents are based on a total weight of said carbonated drink composition.

15. The carbonated drink composition of claim 14, wherein said at least one flavor comprise a cola flavor, and said carbonated drink composition further comprises:
phosphoric acid in an amount ranging from about 0.0001 to about 0.0010 wt % based on a total weight of said carbonated drink composition.

16. The carbonated drink composition of claim 14, wherein said at least one flavor comprise an orange flavor, and said carbonated drink composition further comprises:
citric acid in an amount ranging from about 0.0010 to about 0.0030 wt %; and
sodium benzoate in an amount ranging from about 0.0001 to about 0.0010 wt %;
wherein all weight percents are based on a total weight of said carbonated drink composition.

17. The carbonated drink composition of claim 12, wherein said combination of natural sweeteners comprises a weight ratio of stevia to erythritol ranging from about 1:4 to about 1:6.

18. A carbonated drink composition comprising:
carbonated water in an amount ranging from about 99.980 to about 99.995 wt %, said carbonated water containing at least about 0.005 wt % carbon dioxide or carbonic acid;
stevia in an amount ranging from about 0.0001 to about 0.0010 wt %;
erythritol in an amount ranging from about 0.0010 to about 0.0050 wt %; and
at least one flavor in an amount ranging from about 0.0010 to about 0.0050 wt %; and
one or more additives selected from the group consisting of phosphoric acid, citric acid, sodium benzoate, and any combination thereof;
wherein all weight percents are based on a total weight of said carbonated drink composition; and said carbonated drink composition is substantially free of artificial sweeteners and contains no calories and has less than about 1.0 carbohydrates per twelve ounce serving.

19. The carbonated drink composition of claim 18, wherein said at least one flavor comprise a cola flavor, and said carbonated drink composition further comprises:
phosphoric acid in an amount ranging from about 0.0001 to about 0.0010 wt % based on a total weight of said carbonated drink composition.

20. The carbonated drink composition of claim 18, wherein said at least one flavor comprise an orange flavor, and said carbonated drink composition further comprises:
citric acid in an amount ranging from about 0.0010 to about 0.0030 wt %; and
sodium benzoate in an amount ranging from about 0.0001 to about 0.0010 wt %;
wherein all weight percents are based on a total weight of said carbonated drink composition.
